(19) United States
(12) Patent Application Publication
(10) Pub. No.: US 2010/0035764 A1
(43) Pub. Date: Feb. 11, 2010

(54) METHODS AND COMPOSITIONS FOR MONITORING T CELL RECEPTOR DIVERSITY

(75) Inventors: Xiaohua Chen, Memphis, TN (US); Geoffrey A. M. Neale, Germantown, TN (US); Rupert Handgretinger, Cordova, TN (US)

Correspondence Address: ALSTON AND BIRD LLP;ST. JUDE CHILDREN'S RESEARCH HOSPITAL, BANK OF AMERICA PLAZA, 101 SOUTH TRYON STREET, SUITE 4000, CHARLOTTE, NC, 28280-4000, US

(73) Assignee: St. Jude Children's Research Hospital, Memphis, TN (US)

(21) Appl. No.: 12/442,421

(22) PCT Filed: Sep. 21, 2007
(86) PCT No.: PCT/US07/79108

§ 371 Date: Sep. 18, 2009

Related U.S. Application Data
(60) Provisional application No. 60/847,335, filed on Sep. 26, 2006.

(51) Int. Cl. C40B 30/04; C40B 40/06

(52) U.S. Cl. 506/9; 506/16

(57) ABSTRACT

The present invention provides an array for use in a method of monitoring T cell diversity. The array comprises a substrate having a plurality of capture probes that can specifically bind to a nucleic acid molecule corresponding to a T cell receptor (TCR) gene family selected from the group consisting of the TCR gene families listed in Table 1. In one format, the system has one or more oligonucleotide capture probes wherein each probe is selected from the group consisting of SEQ ID NO: 1-41. Further provided are methods for monitoring T cell diversity in a subject following, for example, allogeneic hematopoietic stem cell transplantation, or other treatment or therapy that contributes to an alteration in T cell population and/or diversity. Compositions of the invention include arrays, computer readable media, and kits for use in the methods of the invention.

### FEDERALLY SPONSORED RESEARCH OR DEVELOPMENT

The research underlying a portion of this invention was supported in part with funds from the National Institute of Health, grant number CA21765, the Assissi Foundation of Memphis, and the American Lebanese Syrian Associates Charities (ALSAC).

### FIELD OF THE INVENTION

The present invention relates generally to expression profiling, particularly receptor profiling to monitor T cell diversity.

### BACKGROUND OF THE INVENTION

T cell reconstitution following, for example, allogeneic hematopoietic stem cell transplantation (AHSCT), is potentially achieved through 2 pathways: the thymus-dependent differentiation of donor progenitors and thymus-independent peripheral expansion of mature T cells in the recipient (Haynes et al. (2000) Ann Rev Immunol 18:529-560). Thymus-dependent reconstitution results in T cell polyclonal expansion with a highly diverse TCR repertoire. Thymus-independent T cell reconstitution has given a feature of T cell monoclonal expansion with a restricted repertoire (Doueck et al. (2000) Lancet 355:1875-1881; Dumont-Girard et al. (1998) Blood 92:4464-4471). The latter pattern is also seen in the cases of graft-versus-host disease (GvHD) and opportunistic infections, which are two of the major complications after AHSCT.

Multiparameter flow cytometry has often been used to detect T cell diversity. However, T cells have millions of potential specificities based on both distinct combinations of TCR variable region (V region) and joining region (J region), and the hypervariable complementarity-determining region 3 (CDR3), which is non-germline-encoded and is thought to carry the fine specificity of antigen recognition by T cells. With such complex populations, T cell diversity cannot be adequately tested by flow cytometry. This is especially true for those T cell clones that are distinctive in their CDR3 regions. TCR repertoire CDR3 spectratyping has been a powerful measurement for distinguishing various T cell populations characterized both by different V and J region combination and by distinct CDR3 regions. To obtain information regarding T cell receptor diversity within a biological sample, an individual amplification reaction for each of the V-region families is required (separate reactions). The reactions are then analyzed sequentially on a sequencing gel to evaluate the diversity of the repertoire within each family, and a score is derived by summation across families (reactions). This method can distinguish monoclonal expansion from polyclonal background without further in vitro experiments (Pannetier et al. (1995) Immunol Today 16:176-181). However, it involves numerous PCRs and has been interpreted only as a qualitative assay.

Therefore, a simple, rapid way to quantitatively analyze many TCR genes in parallel is needed.

### SUMMARY OF THE INVENTION

The present invention provides an array for use in a method of monitoring T cell diversity. The array comprises a substrate having a plurality of capture probes that can specifically bind to a nucleic acid molecule corresponding to a T cell receptor (TCR) gene family selected from the group consisting of the TCR gene families listed in Table 1.

The invention also provides a computer-readable medium comprising digitally-encoded expression profiles having values representing the expression of one or more genes corresponding to the TCR gene families shown in Table 1.

The present invention is thus directed to a system for monitoring T cell diversity. In one format, the system has one or more oligonucleotide capture probes wherein each probe specifically binds to a nucleic acid corresponding to a TCR gene family listed in Table 1, or wherein each probe is selected from the group consisting of SEQ ID NO:1-41.

The oligonucleotide capture probes that specifically bind to nucleic acids corresponding to the TCR gene families of the invention may comprise deoxyribonucleic acid (DNA), ribonucleic acid (RNA), protein nucleic acid (PNA), synthetic oligonucleotides, or genomic DNA.

In one embodiment, the probes that specifically bind to nucleic acids corresponding to TCR gene families, particularly TCR beta (TCRβ) gene families, are immobilized on an array. The array may be a chip array, a plate array, a bead array, a pin array, a membrane array, a solid surface array, a liquid array, an oligonucleotide array, a polynucleotide array, a cDNA array, a microfilter plate, a membrane or a chip.

The present invention is further directed to a method of monitoring T cell diversity by obtaining a sample from an individual (herein referred to as “subject sample”), hybridizing nucleic acid derived from the subject sample with an oligonucleotide probe set of the invention, and assessing T cell diversity.

In the present invention, expression may be differential expression, wherein the differential expression is based on the presence or the absence of expression of a nucleic acid corresponding to a TCR gene family of the invention. The differential expression may be between two or more samples from the same subject taken on separate occasions, between two or more separate subjects, or between one or more subjects and cells derived from culture. In some embodiments, T cell diversity is assessed by the presence or absence of expression of a nucleic acid corresponding to a TCR gene family of the invention.

In another embodiment, the invention provides a kit for monitoring T cell diversity. The kit comprises (1) an array having a substrate with a plurality of capture probes that can specifically bind a nucleic acid molecule corresponding to one or more of the genes shown in Table 1; and (2) a computer-readable medium comprising digitally-encoded expression profiles having values representing the expression of a gene selected from the TCR gene families shown in Table 1. In a further embodiment, the capture probes are selected from the group consisting of SEQ ID NO:1-41.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the invention. Although specific terms are employed herein, they are used in a generic and descriptive sense only and not for purposes of limitation.

### Overview

T lymphocytes recognize their antigenic peptides through the action of the heterodimeric T cell receptor (TCR), which is composed of an α and β chain for most mature lymphocytes, although a small proportion of cells use a γδ heterodimer instead (Ferrick et al (1989) Immunol Today 10:403-407). Like the immunoglobulins (Ig), the T cell receptor proteins are encoded in the genome as variable gene segments (V), diversity segments (D; except in the case of α and γ chains), joining segments (J), and constant region genes (C). The random assortment of the various V, D, and J elements, as well as junctional diversity that occurs during recombination, provides an essentially limitless repertoire for antigen recognition. It is estimated that 42α chain variable (TCRAV) gene segments and 47β chain variable (TCRBV) gene segments are functionally expressed. Thus, a measure of the diversity of the TCR genes (i.e., the number of different TCR gene families) that are expressed in a subject is an indicator of T cell diversity. An extensive list of published human T cell receptor variable region gene sequences and their family and subfamily classification can be found in Arden et al. (1995) Immunogenetics 42:455-500 and Toyonaga and Mak (1987) Annu Rev Immunol 5:585-620, both of which are herein incorporated by reference in their entirety.

T cell reconstitution following, for example AHSCT, is potentially achieved by the thymus-dependent differentiation of donor progenitors, and thymus-independent peripheral expansion of mature T cells in the recipient. Thymus-dependent T cell reconstitution has often been shown to yield a highly diverse TCR repertoire, while thymus-independent T cell reconstitution involves of T cell monoclonal expansion with a restricted repertoire. With millions of potential specificities, it is difficult to measure all of the complex T cell populations using standard methodologies.

The present invention provides compositions that are useful in monitoring T cell diversity in a subject following, for example, AHSCT or other treatment or therapy that contributes to an alteration in T cell population and/or diversity (e.g., immunosuppressive therapy, infection, cancer, autoimmune disorder, etc). These compositions include arrays comprising a substrate having one or more capture probes that can bind specifically to nucleic acid molecules that correspond to the TCR gene families of the invention. By “TCR gene family” or “TCR gene families” is intended a set of TCR genes with a high degree of sequence similarity, typically at least 75% sequence identity. See Toyonaga and Mak, 1987, supra. By “nucleic acid molecules that correspond to a TCR gene family” is intended a nucleic acid that falls within the sequence range for a given TCR family or subfamily. For example, a nucleic acid that corresponds to the TCRβVB2 gene family has at least 75% sequence identity to at least the coding region of other genes in that family. Where the nucleic acid is an mRNA species, the gene encoding that mRNA species has at least 75% sequence identity to the other genes in that family. A comprehensive analysis of TCR gene family classification can be found in Toyonaga and Mak, 1987, supra, or in Arden et al. 1995, supra.

In one aspect, the present invention also provides a computer-readable medium having digitally encoded reference profiles useful in the methods of the claimed invention. The invention also encompasses kits comprising an array of the invention and a computer-readable medium having digitally-encoded reference profiles with values representing the expression of nucleic acid molecules detected by the arrays.

A. Expression Profiling

In one embodiment of the present invention, expression patterns, or profiles, of a plurality of TCR gene families are evaluated in one or more subject samples. For the purpose of discussion, the term subject, or subject sample, refers to an individual regardless of health and/or disease status. A subject can be a patient, a study participant, a control subject, a screening subject, or any other class of individual from whom a sample is obtained and assessed in the context of the invention. Accordingly, a subject can be diagnosed with a disease that affects T cell populations, can present with one or more symptoms of a disease that affects T cell populations, or a predisposing factor, such as a family (genetic) or medical history (medical) factor, for a disease that affects T cell populations, can be undergoing treatment or therapy in which the treatment or therapy affects the subject's T cell population, or the like. Alternatively, a subject can be healthy with respect to any of the aforementioned factors or criteria. It will be appreciated that the term “healthy” as used herein, is relative to a specified disease that affects T cell populations, or disease factor, or disease criterion, as the term “healthy” cannot be defined to correspond to any absolute evaluation or status. Thus, an individual defined as healthy with reference to any specified disease or disease criterion, can in fact be diagnosed with any other one or more disease, or exhibit any other one or more disease criterion.

In some embodiments, an expression profile is produced for the subject sample before and after AHSCT or other treatment or therapy resulting from or contributing to an alteration in T cell population. An alteration in T cell population can include an increase or decrease in the total number of T cells and/or the diversity of the T cell population. An alteration in T cell populations can be the result of, for example, hematopoietic stem cell transplant; graft versus host disease following, for example, treatment or therapy for cancer; immunodeficiency diseases including: genetic diseases; T cell malignancies, such as leukemia or lymphoma; infections, including bacterial, viral and fungal infections; or from auto-immune disease, including, for example, Hashimoto's thyroiditis, pernicious anemia, Addison's disease, diabetes, rheumatoid arthritis, systemic lupus erythematosus, Sjogren's syndrome, multiple sclerosis, myasthenia gravis, Reiter's syndrome, Graves' disease and Crohn's disease. For the purposes of the present invention, the diversity of the T cell population refers to the number of different gene families encoding T cell receptor proteins detectable in a biological sample derived from a subject. A “biological sample” can comprise cells, tissue, cell culture, bone marrow, blood, or other bodily fluids.

In other embodiments, the expression profiles of the present invention are generated from samples taken from subjects undergoing allogeneic hematopoietic stem cell transplant. However, it is understood that T cell diversity can be monitored in a subject using the methods of the present invention under any circumstance, regardless of the health status of the subject. The samples from the subject used to generate the expression profiles of the present invention can be derived from a variety of sources including, but not limited to, a collection of cells, tissue, cell culture, bone marrow, blood, or other bodily fluids. The tissue or cell source may include a tissue biopsy sample, a cell sorted population, or a cell culture. Sources for the sample of the present invention include cells from peripheral blood or bone marrow, such as mononuclear cells from peripheral blood or bone marrow. Furthermore, while the discussion of the invention focuses on, and is exemplified using, human sequences and samples, the invention is equally applicable, through construction or selection of appropriate candidate TCR gene segments, to non-human animals, such as laboratory animals, e.g., mice, rats, guinea pigs, rabbits; domesticated livestock, e.g., cows, horses, goats, sheep, chicken, etc.; and companion animals, e.g., dogs, cats, etc.

As used herein, an “expression profile” comprises one or more values corresponding to a measurement of the relative abundance, presence, or absence of a gene expression product. Such values will correspond to the TCR repertoire and may include measurements of RNA levels or protein abundance. Thus, the expression profile can comprise values representing the measurement of the transcriptional state or the translational state of a TCR gene of the invention. See, U.S. Pat. Nos. 6,040,138, 5,800,992, 6,020135, 6,344,316, and 6,033,860, which are hereby incorporated by reference in their entireties. An expression profile can be derived from a biological sample collected from a subject at one or more time points prior to or following treatment or therapy that results from or contributes to an alteration in T cell populations, collected from a healthy subject, or collected from cells in culture.

The transcriptional state of a sample includes the identities and relative abundance of the RNA species, especially mRNAs encoding TCR proteins present in the sample. Preferably, a substantial fraction of all constituent RNA species in the sample are measured, but at least a sufficient fraction to characterize the transcriptional state of the sample is measured. The transcriptional state can be conveniently determined by measuring transcript presence or absence by any of several existing gene expression technologies.

The expression profiles according to the invention comprise one or more values representing the TCR repertoire. Each expression profile contains a sufficient number of values such that the profile can be used to characterize T cell diversity. In some embodiments, the expression profiles comprise only one value. As used herein, “value” refers to a particular gene or gene segment corresponding to a TCR family, for example, one or more of the gene families shown in Table 1. In other embodiments, the expression profile comprises more than one value corresponding to a TCR gene family, for example at least 2 values, at least 3 values, at least 4 values, at least 5 values, at least 6 values, at least 7 values, at least 8 values, at least 9 values, at least 10 values, at least 11 values, at least 12 values, at least 13 values, at least 14 values, at least 15 values, at least 16 values, at least 17 values, at least 18 values, at least 19 values, at least 20 values, at least 22 values, at least 25 values, at least 27 values, at least 30 values, at least 35 values, or at least 40 or more values.

TABLE 1

| TCRβ | | SEQ ID |
|---|---|---|
| family | Probe sequence | NO: |
| VB2 | CATCAACCATGCAAGCCTGACCTTGTCCACTCTGACAGTGACCAG | 1 |
| | TGCCCATC | |
| VB3 | AGTGTCTCTAGAGAGAAGAAGGAGCGCTTCTCCCTGATTCTGGAG | 2 |
| | TCCGCCAGCAC | |
| VB4 | CATCAGCCGCCCAAACCTAACATTCTCAACTCTGACTGTGAGCAA | 3 |
| | CATGAGCCCTGA | |
| VB5.1 | GGTCGATTCTCAGGGCGCCAGTTCTCTAACTCTCGCTCTGAGATG | 4 |
| | AATGTGAGCACCT | |
| VB5.3 | ATTCTCAGCTCGCCAGTTCCCTAACTATAGCTCTGAGCTGAATGTG | 5 |
| | AACGCCTTGTTGCT | |
| VB6.1 | GTTCTTTGCAGTCAGGCCTGAGGGATCCGTCTCTACTCTGAAGAT | 6 |
| | CCAGCGCACAGA | |
| VB6.4 | GTTCTCTGCAGAGAGGCCTAAGGGATCTTTCTCCACCTTGGAGAT | 7 |
| | CCAGCGCA | |
| VB7 | CCTGAATGCCCCAACAGCTCTCACTTATTCCTTCACCTACACACCC | 8 |
| | TGCAGCCAGAA | |
| VB8 | TCAGCTAAGATGCCTAATGCATCATTCTCCACTCTGAGGATCCAG | 9 |
| | CCCTCAGAACCCAGG | |
| VB9 | CACCTAAATCTCCAGACAAAGCTCACTTAAATCTTCACATCAATT | 10 |
| | CCCTGGAGCTTGGTG | |
| VB10 | AGCCCAATGCTCCAAAAACTCATCCTGTACCTTGGAGATCCAGTC | 11 |
| | CACGGAGTCAGG | |
| VB11 | GAGCATTTTCCCCTGACCCTGGAGTCTGCCAGGCCCTCACATACC | 12 |
| | TCTCA | |
| VB12 | AGTGTCTCTAGATCAAAGACAGAGGATTTCCTCCTCACTCTGGAG | 13 |
| | TCCGCTACCAGCTCC | |
| VB13 | TCCAGATCAACCACAGAGGATTTCCCGCTCAGGCTGGAGTCGGCT | 14 |
| | GCTCC | |
| VB14 | AGTCTCTCGAAAAGAGAAGAGGAATTTCCCCCTGATCCTGGAGTC | 15 |
| | GCCCAGCC | |
| VB15 | GATACAGTGTCTCTCGACAGGCACAGGCTAAATTCTCCCTGTCCC | 16 |
| | TAGAGTCTGCCATCC | |
| VB16 | GACTGGAGGGACGTATTCTACTCTGAAGGTGCAGCCTGCAGAACT | 17 |
| | GGAGGATTCTGGAGT | |
| VB17 | AGCGTCTCTCGGGAGAAGAAGGAATCCTTTCCTCTCACTGTGACA | 18 |
| | TCGGCCCA | |
| VB18 | ATTTCCCAAAGAGGGCCCCAGCATCCTGAGGATCCAGCAGGTAGT | 19 |
| | GCGAGGA | |
| VB19 | AGAATGAACAAGTTCTTCAAGAAACGGAGATGCACAAGAAGCGA | 20 |
| | TTCTCATCTCAATGCC | |
| VB20 | CCAGGACCGGCAGTTCATCCTGAGTTCTAAGAAGCTCCTTCTCAG | 21 |
| | TGACTCTGGCTT | |
| VB23 | TCGATTCTCAGCTCAACAGTTCAGTGACTATCATTCTGAACTGAA | 22 |
| | CATGAGCTCCTTGGAGC | |
| VB24 | AATCCAGGAGGCCGAACACTTCTTTCTGCTTTCTTGACATCCGCTC | 23 |
| | ACCAGGCCT | |
| VB25 | TCAGCTAAGTGCCTCCCAAATTCACCCTGTAGCCTTGAGATCCAG | 24 |
| | GCTACGAAGCTTGAG | |
| VB27 | ATGCCCTGACAGCTCTCGCTTATACCTTCATGTGGTCGCACTGCAG | 25 |
| | CAAGAAGACTCA | |
| VB28 | TTGAAATACTATAGCATCTTTTCCCCTGACCCTGAAGTCTGCCAGC | 26 |
| | ACCAACCAGACATC | |
| VB29 | CAAGAGGAGAAGGGGCTATTTCTTCTCAGGGTGAAGTTGGCCCAC | 27 |
| | ACCAGCCAA | |
| VB30 | TGGAAACAAGCTCAAGCATTTTCCCTCAACCCTGGAGTCTACTAG | 28 |
| | CACCAGCCAGACCTC | |
| JB1.1 | ACACTGAAGCTTTCTTTGGACAAGGCACCAGACTCACAGTTG | 29 |
| JB1.2 | ACTATGGCTACACCTTCGGTTCGGGGACCAGGTTAACCGTTG | 30 |
| JB1.3 | TGGAAACACCATATATTTTGGAGAGGGAAGTTGGCTCACTGTTG | 31 |
| JB1.4 | CTAATGAAAAACTGTTTTTTGGCAGTGGAACCCAGCTCTCTGTCT | 32 |
| JB1.5 | CAATCAGCCCCAGCATTTTGGTGATGGGACTCGACTCTCCATCC | 33 |
| JB1.6 | TATAATTCACCCCTCCACTTTGGGAATGGGACCAGGCTCACTGTG | 34 |
| | AC | |
| JB2.1 | CTACAATGAGCAGTTCTTCGGGCCAGGGACACGGCTCACCGTGC | 35 |
| JB2.2 | ACACCGGGGAGCTGTTTTTTGGAGAAGGCTCTAGGCTGACCGTAC | 36 |
| JB2.3 | ACAGATACGCAGTATTTTGGCCCAGGCACCCGGCTGACAGTGC | 37 |
| JB2.4 | AACATTCAGTACTTCGGCGCCGGGACCCGGCTCTCAGTGC | 38 |
| JB2.5 | AAGAGACCCAGTACTTCGGGCCAGGCACGCGGCTCCTGGT | 39 |
| JB2.6 | AACGTCCTGACTTTCGGGGCCGGCAGCAGGCTGACCGT | 40 |
| JB2.7 | CTACGAGCAGTACTTCGGGCCGGGCACCAGGCTCACGGTCAC | 41 |

In various embodiments of the present invention, the expression profile derived from a subject is compared to a reference expression profile. A “reference expression profile” can be a profile derived from the subject prior to transplant, treatment or therapy; can be the profile produced from the subject sample at a particular time point (usually prior to or following transplant, treatment or therapy); can be derived from a healthy individual or a pooled reference from healthy individuals, or can be derived from cells in culture (e.g., leukemic cells). In some embodiments, the reference expression profile represents a T cell population of high diversity.

Alternatively, the reference expression profile is one in which few or none of the TCR gene families of the invention are detectable (e.g., T cell diversity that is low). As an example of this approach, a subject expression profile following AHSCT (which would be of low TCR diversity) can be used as a reference expression profile to monitor T cell reconstitution in that subject at time points subsequent to AHSCT. In another example, the reference expression profile is derived from cells in culture that are known to exhibit low T cell diversity (e.g., Jurkat or Molt-4 T-lineage leukemia cell lines).

The reference expression profile can be compared to a test expression profile. A “test expression profile” can be derived from the same subject as the reference expression profile except at a subsequent time point (e.g., one or more days, weeks or months following collection of the reference expression profile) or can be derived from a different subject. In summary, any test expression profile of a subject can be compared to a previously collected profile from the same subject (either before or after transplant, treatment or therapy) or to a profile obtained from a healthy individual or to a profile generated from cells in culture. An increase in the TCR repertoire in the test expression profile compared to the reference expression profile is considered to represent an increase in T cell diversity.

Numerous methods for obtaining data related to T cell diversity are known, and any one or more of these techniques, singly or in combination, are suitable for determining expression profiles in the context of the present invention. For example, expression patterns can be evaluated by Northern analysis, PCR, RT-PCR, Taq Man analysis, FRET detection, monitoring one or more molecular beacons, hybridization to an oligonucleotide array, hybridization to a cDNA array, hybridization to a polynucleotide array, hybridization to a liquid microarray, hybridization to a microelectric array, molecular beacons, cDNA sequencing, clone hybridization, cDNA fragment fingerprinting, serial analysis of gene expression (SAGE), subtractive hybridization, differential display and/or differential screening (see, e.g., Lockhart and Winzeler (2000) Nature 405: 827-836, and references cited therein).

Molecular beacons can be used to assess the presence of multiple nucleotide sequences at once. Molecular beacons with sequence complementary to the TCR gene families disclosed in Table 1 are designed and linked to fluorescent labels. Each fluorescent label used must have a non-overlapping emission wavelength. For example, 10 nucleotide sequences can be assessed by hybridizing 10 sequence-specific molecular beacons (each labeled with a different fluorescent molecule) to an amplified or un-amplified RNA or cDNA sample. Such an assay bypasses the need for sample labeling procedures.

Alternatively, or in addition, bead arrays can be used to assess expression of multiple sequences at once. See, e.g, LabMAP 100 (Luminex Corp, Austin, Tex.). Alternatively, or in addition, electric arrays are used to assess expression of multiple sequences, as exemplified by the ESENSOR® technology (Osmetech, Roswell, Ga.) or NANOCHIP® technology of Nanogen (San Diego, Calif.).

Of course, the particular method elected will be dependent on such factors as quantity of RNA recovered, artisan preference, available reagents and equipment, detectors, and the like. Typically, however, the elected method(s) will be appropriate for processing the number of samples and probes of interest. Methods for high-throughput expression analysis are described elsewhere herein.

B. Sample Collection and Preparation

To assess T cell diversity in a subject sample, nucleic acids and/or proteins derived from a subject sample are initially manipulated according to well known molecular biology techniques. Detailed protocols for numerous such procedures are described in, e.g., in Ausubel, et al. (2000) Current Protocols in Molecular Biology, John Wiley & Sons, New York; Sambrook et al. (1989) Molecular Cloning—A Laboratory Manual (2nd Ed.), Cold Spring Harbor Laboratory Press, Cold Spring Harbor, N.Y.; and, Berger and Kimmel (1987) Guide to Molecular Cloning Techniques: Methods in Enzymology, Academic Press, Inc., San Diego, Calif.

In one embodiment, RNA is isolated from whole blood using a phenol-guanidine isothiocyanate reagent or another direct whole-blood lysis method, as described in, e.g., U.S. Pat. Nos. 5,346,994 and 4,843,155. This method may be less preferred under certain circumstances because the large majority of the RNA recovered from whole blood RNA extraction comes from erythrocytes since these cells outnumber leukocytes 1000:1. Care must be taken to ensure that the presence of erythrocyte RNA and protein does not introduce bias in the RNA expression profile data or lead to inadequate sensitivity or specificity of probes.

Alternatively, intact leukocytes may be collected from whole blood using a lysis buffer that selectively lyses erythrocytes, but not leukocytes, as described, e.g., in (U.S. Pat. Nos. 5,973,137, and 6,020,186). Intact leukocytes are then collected by centrifugation, and leukocyte RNA is isolated using standard protocols, as described herein. However, this method does not allow isolation of sub-populations of leukocytes, e.g. mononuclear cells, which may be desired.

Alternatively, specific leukocyte cell types can be separated using density gradient reagents (Boyum, A, 1968.). For example, mononuclear cells may be separated from whole blood using density gradient centrifugation, as described, e.g., in U.S. Pat. Nos. 4,190,535, 4,350,593, 4,751,001, 4,818,418, and 5,053,134. Blood is drawn directly into a tube containing an anticoagulant and a density reagent (such as Ficoll or Percoll). Centrifugation of this tube results in separation of blood into an erythrocyte and granulocyte layer, a mononuclear cell suspension, and a plasma layer. The mononuclear cell layer is easily removed and the cells can be collected by centrifugation, lysed, and frozen. Frozen samples are stable until RNA can be isolated.

In another approach, a microfluidics chip is used for RNA sample preparation and analysis. This approach increases efficiency because sample preparation and analysis are streamlined. Briefly, microfluidics may be used to sort specific leukocyte sub-populations prior to RNA preparation and analysis. Microfluidics chips are also useful for, e.g., RNA preparation, and reactions involving RNA (reverse transcription, RT-PCR). Briefly, a small volume of whole, anti-coagulated blood is loaded onto a microfluidics chip, for example chips available from Caliper (Mountain View, Calif.) or Nanogen (San Diego, Calif.). A microfluidics chip may contain channels and reservoirs in which cells are moved and reactions are performed. Mechanical, electrical, magnetic, gravitational, centrifugal or other forces are used to move the cells and to expose them to reagents. For example, cells of whole blood are moved into a chamber containing hypotonic saline, which results in selective lysis of red blood cells after a 20-minute incubation. Next, the remaining cells are moved into a wash chamber and finally, moved into a chamber containing a lysis buffer such as guanidine isothiocyanate. The cell lysate is further processed for RNA isolation in the microfluidics chip, or is then removed for further processing, for example, RNA extraction by standard methods. Alternatively, the microfluidics chip is a circular disk containing ficoll or another density reagent. The blood sample is injected into the center of the disc, the disc is rotated at a speed that generates a centrifugal force appropriate for density gradient separation of, for example, mononuclear cells, and the separated mononuclear cells are then harvested for further analysis or processing.

The quality and quantity of each clinical RNA sample is desirably checked before further processing and analysis using methods known in the art. For example, one microliter of each sample may be analyzed on a Agilent 2100 Bioanalyzer (Agilent Technologies) using an RNA 6000 Nano LABCHIP® kit (Agilent Technologies).n Degraded RNA is identified by the reduction of the 28S to 18S ribosomal RNA ratio and/or the presence of large quantities of RNA in the 25 -100 nucleotide range.

C. Probes

For the purposes of assessing T cell receptor diversity, the invention also provides TCR capture probe sets. By “capture probe” is intended any molecule and/or reagent capable of specifically identifying a nucleotide sequence corresponding to a TCR gene family listed in Table 1. The capture probes are designed to hybridize to target nucleic acid molecules corresponding to TCR gene families (such as cDNA copies of messenger RNAs) and allow their detection. Methods of designing probes that will hybridize to a target nucleic acid molecule are well known in the art. Any capture probe that detects a TCR gene family of the invention may be used.

In some embodiments, the capture probes bind nucleotide sequences that correspond to gene segments that encode T cell receptor beta (TCRβ) proteins. The gene segments can be TCR receptor variable gene segments (V), diversity segments (D), and/or joining segments (J). In another embodiment, each capture probe in the array detects a nucleic acid molecule corresponding to a TCR gene gamily listed in Table 1. In yet a further embodiment, the each capture probe is selected from the group consisting of SEQ ID NO:1-41. The population of TCR gene families detectable in a subject is referred to herein as the “TCR repertoire.”

Variants and fragments of the disclosed oligonucleotide capture probes may be used in the present invention. It is further understood that variants and fragments of the oligonucleotide primer and/or probe sequences disclosed herein can be used in the methods of the invention. For example, the oligonucleotides can be shorter or longer (e.g., addition or deletion of 1, 2, 3, 4, 5, 6, 7, 8, 9, 10 or more nucleotides to the 5′ and or 3′ end of the oligonucleotide) than the oligonucleotides disclosed herein as SEQ ID NO:1-41, or may have 1 to 5, or 5 to 10, nucleotide substitutions so long as the oligonucleotide capture probes retain the ability to hybridize to the target nucleic acid under the appropriate conditions. Therefore, variants and fragments of the oligonucleotides of the invention will have about 70%, about 75%, about 80%, 85%, 86%, 87%, 88%, 89%, 90%, 91%, 92%, 93%, 94%, 95%, 96%, 97%, 98%, or about 99% or greater sequence identity to the sequences disclosed herein as SEQ ID NO:1-41. It is understood in the art that the degree of sequence identity required to detect gene expression varies depending on the length of the probe sequence. For a 60 base oligonucleotide sequence, 6-8 random mutations or 6-8 random deletions do not affect gene expression detection (Hughes, et al. (2001) Nature Biotechnology, 19:343-347). As the length of the oligonucleotide probe is increased, the number of mutations or deletions permitted while still allowing TCR detection is increased.

In a preferred embodiment, each capture probe comprises an oligonucleotide that hybridizes to a nucleic acid corresponding to a TCR gene family disclosed in Table 1. In another embodiment, each capture probe comprises an oligonucleotide selected from the group consisting of SEQ ID NO:1-41. The term “oligonucleotide” refers to two or more nucleotides. Nucleotides may be DNA or RNA, naturally occurring or synthetic.

Oligonucleotide capture probes can be synthesized utilizing various solid-phase strategies involving mononucleotide- and/or trinucleotide-based phosphoramidite coupling chemistry. For example, nucleic acid sequences can be synthesized by the sequential addition of activated monomers and/or trimers to an elongating polynucleotide chain. See e.g., Caruthers, M. H. et al. (1992) Meth Enzymol 211:3.

In lieu of synthesizing the desired sequences, essentially any nucleic acid can be custom ordered from any of a variety of commercial sources, such as The Midland Certified Reagent Company (Midland, Tex.), ExpressGen, Inc. (Chicago, Ill.), Operon Technologies, Inc. (Huntsville, Ala.), and many others.

Similarly, commercial sources for standard as well as custom nucleic acid and protein microarrays are available, and include, e.g., Agilent Technologies (Palo Alto, Calif.), Affymetrix (Santa Clara, Calif.), and others.

D. Arrays

In one embodiment of the present invention, the capture probes are immobilized on an array. By “array” is intended a solid support or substrate with peptide or nucleic acid probes attached to the support or substrate. Arrays typically comprise a plurality of different nucleic acid or peptide capture probes that are coupled to a surface of a substrate in different, known locations. The arrays of the invention comprise a substrate having a plurality of capture probes that can specifically bind a target nucleic acid molecule. The number of capture probes on the substrate varies with the purpose for which the array is intended. The arrays may be low-density arrays or high-density arrays and may contain 4 or more, 8 or more, 12 or more, 16 or more, 20 or more, 24 or more, 32 or more, 40 or more, 48 or more, 64 or more, 72 or more 80 or more, 96, or more addresses. In some embodiments, the substrate has no more than 12, 24, 48, 96, or 192, or no more than 384 addresses.

Techniques for the synthesis of these arrays using mechanical synthesis methods are described in, e.g., U.S. Pat. No. 5,384,261, incorporated herein by reference in its entirety for all purposes. Although a planar array surface is preferred, the array may be fabricated on a surface of virtually any shape or even a multiplicity of surfaces. Arrays may be peptides or nucleic acids on beads, gels, polymeric surfaces, fibers such as fiber optics, glass or any other appropriate substrate, see U.S. Pat. Nos. 5,770,358, 5,789,162, 5,708,153, 6,040,193 and 5,800,992, each of which is hereby incorporated in its entirety for all purposes. Arrays may be packaged in such a manner as to allow for diagnostics or other manipulation of an all-inclusive device. See, for example, U.S. Pat. Nos. 5,856,174 and 5,922,591 herein incorporated by reference.

Alternatively, a variety of solid phase arrays can favorably be employed to determine T cell diversity in the context of the invention. Exemplary formats include membrane or filter arrays (e.g, nitrocellulose, nylon), pin arrays, and bead arrays (e.g., in a liquid “slurry”). Typically, probes corresponding to nucleic acid or protein reagents that specifically interact with (e.g., hybridize to or bind to) an expression product corresponding to the TCR gene families of the invention are immobilized, for example by direct or indirect cross-linking, to the solid support. Essentially any solid support capable of withstanding the reagents and conditions necessary for performing the particular expression assay can be utilized. For example, functionalized glass, silicon, silicon dioxide, modified silicon, any of a variety of polymers, such as (poly)tetrafluoroethylene, (poly)vinylidenedifluoride, polystyrene, polycarbonate, or combinations thereof can all serve as the substrate for a solid phase array.

In a preferred embodiment, the array is a “chip” composed, e.g., of one of the above specified materials. Polynucleotide probes, preferably synthetic oligonucleotides and the like, or binding proteins such as antibodies, that specifically interact with expression products are affixed to the chip in a logically ordered manner, i.e., in an array.

Detailed discussion of methods for linking nucleic acids and proteins to a chip substrate, are found in, e.g., U.S. Pat. Nos. 5,143,854; 5,837,832; 6,087,112; 5,215,882; 5,707,807; 5,807,522; 5,958,342; 5,994,076; 6,004,755; 6,048,695; 6,060,240; 6,090,556; and, 6,040,138, each of which are hereby incorporated by reference in their entirety.

In one embodiment of the invention, microarrays are used to assess T cell diversity. Microarrays are particularly well suited for this purpose because of the reproducibility between different experiments. Each array consists of a reproducible pattern of capture probes attached to a solid support. Labeled RNA or DNA from the subject sample and the reference sample is hybridized to complementary probes on the array (e.g., capture probes of the invention) and then detected by laser scanning. Labeling of the RNA or DNA can be performed according to methods well known in the art using commercially available dyes, fluorophores, or the like. For example, the reference sample can be labeled with one fluorophore (e.g., Cy3 or Cy5), and the test sample can be labeled with a different, distinguishable fluorophore (e.g., the other of Cy3 or Cy5).

Hybridization intensities for each probe on the array are determined and converted to a qualitative or quantitative value representing the presence or absence of the TCR gene families of the invention. See, the Experimental section. See also, U.S. Pat. Nos. 6,040,138, 5,800,992 and 6,020,135, 6,033,860, and 6,344,316, which are incorporated herein by reference. High-density oligonucleotide arrays are particularly useful for assessing T cell diversity in a large number of samples.

Hybridization signal maybe amplified using methods known in the art, and as described herein, for example use of the ATLAS™ Glass Fluorescent Labeling Kit (Clontech), FAIRPLAY™ Microarray Labeling Kit (Stratagene), or the MICROMAX™ kit (PerkinElmer Life and Analytical Sciences), or linear amplification, e.g. as described in U.S. Pat. No. 6,132,997 or described in Hughes, et al. supra and/or Westin et al. (2000) Nature Biotechnology 18(2): 199-204.

Microarray expression may be detected by scanning the microarray with a variety of laser or CCD-based scanners, and extracting features with numerous software packages, for example, IMAGENE® (Biodiscovery, Inc., El Segundo, Calif.), Feature Extraction Software (Agilent Technologies, Palo Alto, Calif.), Scanalyze (Eisen (1999) SCANALYZE User Manual; Stanford Univ., Stanford, Calif. Ver 2.32.), or GENEPIX® (Molecular Devices, Sunnyvale, Calif.).

In order to facilitate ready access, e.g., for comparison, review, recovery, and/or modification, the molecular signatures/expression profiles are typically recorded in a database. Most typically, the database is a relational database accessible by a computational device, although other formats, e.g., manually accessible indexed files of expression profiles as photographs, analogue or digital imaging readouts, spreadsheets, etc. can be used. Further details regarding preferred embodiments are provided below. Regardless of whether the expression patterns initially recorded are analog or digital in nature and/or whether they represent quantitative or qualitative differences in expression, the expression patterns, expression profiles (collective expression patterns), and molecular signatures (correlated expression patterns) are stored digitally and accessed via a database. Typically, the database is compiled and maintained at a central facility, with access being available locally and/or remotely.

E. Assessing Diversity

The term “monitoring” or “assessing” is used herein to describe the use of the capture probes of the invention to provide useful information about an individual or an individual's health or T cell status. “Monitoring” can include, determination of prognosis, risk-stratification, selection of drug therapy, assessment of ongoing drug therapy, prediction of outcomes, determining response to therapy, diagnosis of a disease or disease complication, following progression of a disease or providing any information relating to a subject's health status, particularly T cell status. “Assessing” refers to the enumeration of TCR gene families of the invention that are detectable in a sample derived from a subject.

When referring to a pattern of expression, a “qualitative” difference in TCR gene expression refers to a difference that is not assigned a relative value. That is, such a difference is designated by an “all or nothing” valuation. Such an all or nothing valuation can be, for example, expression above or below a threshold of detection (an on/off pattern of expression) or can represent the “presence” or “absence” of expression. Alternatively, a qualitative difference can refer to expression of different types of expression products, e.g., different alleles (e.g., a mutant or polymorphic allele), variants (including sequence variants as well as post-translationally modified variants), T cell receptor subtypes, etc.

In contrast, a “quantitative” difference, when referring to a pattern of TCR gene expression, refers to a difference in expression that can be assigned a value on a graduated scale, (e.g., a 0-5 or 1-10 scale, a +-+++ scale, a grade 1-grade 5 scale, or the like). It will be understood that the numbers selected for illustration are entirely arbitrary and in no way are meant to be interpreted to limit the invention. Any graduated scale (or any symbolic representation of a graduated scale) can be employed in the context of the present invention to describe quantitative differences in T cell diversity.

Expression patterns can be evaluated by qualitative and/or quantitative measures. Certain of the above described techniques for evaluating gene expression (as RNA or protein products) yield data that are predominantly qualitative in nature. That is, the methods detect differences in expression that classify expression into distinct modes without providing significant information regarding quantitative aspects of expression. For example, a technique can be described as a qualitative technique if it detects the presence or absence of expression of a TCR gene family of the invention, i.e., a yes/no pattern of expression. Alternatively, a qualitative technique measures the presence (and/or absence) of different alleles, or variants, of a gene product.

In contrast, some methods provide data that characterizes expression in a quantitative manner as described above. Typically, such methods yield information corresponding to a relative increase or decrease in expression.

Any method that yields either quantitative or qualitative expression data is suitable for monitoring T cell diversity in a subject sample. In some cases, e.g., when multiple methods are employed to determine expression patterns for a plurality of TCR gene families, the recovered data, e.g., the expression profile, for the nucleotide sequences is a combination of quantitative and qualitative data.

F. Vβ/Jβ Combination Score

T cell diversity can be measured according to the Vβ/Jβ combination score (VJCS) of the subject, which is a qualitative index for the presence/absence of TCRβ gene expression from the total set of Vβ/Jβ families on the array. The VJCS can indicate the extent and clonality of T cell recovery.

The VJCS is based on the generic concept that each Vβ gene can potentially combine with multiple Jβ genes. Multiplication of the numbers of Vβ and Jβ families expressed in a subject provides an estimate of the potential numbers of T cell populations that differ in their TCR Vβ/Jβ combinations. The VJCS for each subject sample is calculated as follows: VJCS=(number of Vβ families expressed by the subject+1)×(number of Jβ families expressed by the subject+1). Other methods to assess T cell diversity are known in the art and described in, for example, the Vβ spectratype complexity score (SCS; Wu et al. (2000) Blood 95, 352-359, which is herein incorporated by reference in its entirety).

G. Scaling

The data may be scaled (normalized) to control for labeling and hybridization variability within the experiment, using methods known in the art. Scaling is desirable because it facilitates the comparison of data between different experiments, subjects, etc. Generally the background subtracted signal is scaled to a factor such as the median, the mean, the trimmed mean, and percentile. Additional methods of scaling include: to scale between 0 and 1, to subtract the mean, or to subtract the median.

Scaling is also performed by comparison to expression profiles obtained using a common reference RNA, as described in greater detail above. As with other scaling methods, the reference RNA facilitates multiple comparisons of the expression data, e.g., between subjects, between samples, across timepoints, etc. Use of a reference RNA provides a consistent denominator for experimental ratios.

H. Statistical Tests

Any method known in the art for comparing two or more data sets to detect similarity between them may be used to compare the subject expression profile to the reference expression profiles. To determine whether two or more expression profiles show statistically significant similarity, statistical tests may be performed to determine whether any differences between the expression profiles are likely to have been achieved by a random event. Methods for comparing gene expression profiles to determine whether they share statistically significant similarity are known in the art and also reviewed in Holloway et al. (2002) Nature Genetics Suppl. 32:481-89, Churchill (2002) Nature Genetics Suppl. 32:490-95, Quackenbush (2002) Nature Genetics Suppl. 32: 496-501; Slonim (2002) Nature Genetics Suppl. 32:502-08; and Chuaqui et al. (2002) Nature Genetics Suppl. 32:509-514; each of which is herein incorporated by reference in its entirety. An expression profile is “distinguishable” or “statistically distinguishable” from a reference profile according to the invention if the two expression profiles do not share statistically significant similarity. The data used to assess statistical significance can be raw data, filtered data, VJCS, SCS, or the like.

I. High Throughput Analysis

A number of suitable high throughput formats exist for monitoring T cell diversity. Typically, the term high throughput refers to a format that performs at least about 100 assays, or at least about 500 assays, or at least about 1000 assays, or at least about 5000 assays, or at least about 10,000 assays, or more per day. When enumerating an assay, either the number of samples or the number of TCR gene families evaluated can be considered. Typically, methods that simultaneously evaluate expression of about 50 or more TCR gene families in one or more samples, or in multiple samples, are considered high throughput.

Numerous technological platforms for performing high throughput expression analysis are known. Generally, such methods involve a logical or physical array of either the subject samples, or the TCR capture probes, or both. Common array formats include both liquid and solid phase arrays. For example, assays employing liquid phase arrays, e.g., for hybridization of nucleic acids, binding of antibodies or other receptors to ligand, etc., can be performed in multiwell, or microtiter, plates. Microtiter plates with 96, 384 or 1536 wells are widely available, and even higher numbers of wells, e.g, 3456 and 9600 can be used. In general, the choice of microtiter plates is determined by the methods and equipment, e.g., robotic handling and loading systems, used for sample preparation and analysis. Exemplary systems include, e.g., the ORCA™ system from Beckman-Coulter, Inc. (Fullerton, Calif.) and the ZYMATE™ systems from Zymark Corporation (Hopkinton, Mass.).

J. Computer-Readable Medium

The invention also provides a computer-readable medium comprising one or more digitally-encoded expression profiles, where each profile has one or more values representing the expression of a TCR gene of the invention. Thus, in one embodiment, the invention encompasses a computer-readable medium comprising digitally-encoded expression profiles having values representing the expression of one or more genes corresponding to the TCR gene families listed in Table 1. In some embodiments, the digitally-encoded expression profiles are compiled in or derived from a database. See, for example, U.S. Pat. No. 6,308,170.

K. Kits

The present invention also provides kits useful for monitoring T cell diversity. These kits comprise an array and reagents sufficient to facilitate hybridization of the nucleic acid derived from the sample to the capture probes and/or reagents sufficient for the detection of the hybridization, including reagents necessary for labeling the probe or the nucleic acid material (e.g., fluorescent dyes). The kit may further comprise a computer readable medium. The array comprises a substrate having a plurality of capture probes that can specifically bind nucleic acid molecules corresponding to T cell receptor gene families of the invention. The computer-readable medium has digitally-encoded expression profiles containing values representing the expression level of a TCR gene detected by the array. In some embodiments, the expression profile is a reference expression profile associated with T cell diversity. The array can be used to produce a test expression profile from a sample, and this test expression profile can then be compared to the reference profile or profiles contained in the computer readable medium to determine whether the test profile shares similarity with the reference profile.

### Experimental Examples

### Materials and Methods

### Subjects

To obtain a reference range for the microarray, the TCRβ repertoire expression pattern of 38 healthy sibling donors whose ages (0 to 20 years) approximated the age range of the patients in this study was tested. The 60 samples studied were obtained from 20 pediatric recipients of AHSCT. This study was approved by the St Jude Children's Research Hospital Institutional Review Board and informed consent was obtained from donors, patients, parents, or guardians, as appropriate.

### Construction of the TCRβ Oligonucleotide Microarray

The array contained 27 TCR Vβ probes and 13 Jβ probes. The oligonucleotides are 50-62-mer sequences for Vβ genes and 38-56-mer for Jβ genes designed according to published sequences (see, Arden et al. (1995) Immunogenetics 42:455-500; and, Lefranc and Lefranc, eds. (2001) The T cell receptor: Facts Book (Academic Press, New York)) using Vector NTI 9.0.0 software. The similarity of the probes was analyzed with Vector NTI 9.0.0 software.

Oligonucleotides were synthesized by using phosphoramidite chemistry and were purified by using a cartridge system (Applied Biosystems, Foster City, Calif.). Oligonucleotides were resuspended in 3×SSC to a concentration of 40 μM and printed on poly-L-lysine-coated 1×3-inch glass slides by using an OMNIGRID® microarray printer (Genomic Solutions, Ann Arbor, Mich.) with 16 CMP4 pins (Telechem, Sunnyvale, Calif.). Each oligonucleotide was printed 48 times with 12 consecutive spots in each of 4 different semi-random areas across the array. After printing, slides were rehydrated, snap-dried and cross-linked by using a STRATALINKER® (Stratagene, La Jolla Calif.) and blocked with succinic anhydride.

Detection of TCRβ repertoire expression by using the microarray The total RNA was purified from Ficoll-enriched PBMNC by using the RNEASY® Mini Kit (QIAGEN Inc, Valencia, Calif.). cDNA was synthesized by using SUPERSCRIPT® II reverse transcriptase and random hexamer primers (Invitrogen Corporation, Carlsbad, Calif.) according to the manufacturer's instructions. PCR was performed in a volume of 100 μl containing 50 μl of AMPLITAQ® Gold Master Mix (Applied Biosystems) and 500 nM TCRVβ primer mix combined with 1 Cβ primer covering both Cβ1 and Cβ2 region sequences (Table 2). The PCR condition was 95° C. for 6 min followed by 30 cycles of 94° C. for 20 sec, 55° C. for 40 sec, 72° C. for 40 sec, and a final extension step of 72° C. for 5 min. The PCR products were purified by using a QIAQUICK® PCR purification kit (QIAGEN Inc.).

TABLE 2

| | | |
|---|---|---|
| | | SEQ |
| TCRβ | | ID |
| family | Primer sequences | NO: |

| | | |
|---|---|---|
| VB2 | AACTATGTTTTGGTATCGTCA* | 42 |
| VB3 | TCTATTTCTCATATGATGTTAAAATGAA | 43 |
| VB4 | CACGATGTTCTGGTACCGTCAGCA* | 44 |
| VB5.1 | CAGTGTGTCCTGGTACCAACAG* | 45 |
| VB5.3 | CAGTGTGTCCTGGTACCAACAG* | 46 |
| VB6.1 | AACCCTTTATTGGTACCGACA* | 47 |
| VB6.4 | AACCCTTTATTGGTACCGACA* | 48 |
| VB7 | GCCACTGGAGCTCATGTTTGT | 49 |
| VB8 | CTCCCGTTTTCTGGTACAGACAGAC* | 50 |
| VB9 | CGCTATGTATTGGTATAAACAG* | 51 |
| VB10 | TTATGTTTACTGGTATCGTAAGAAGC* | 52 |
| VB11 | CAAAATGTACTGGTATCAACAA* | 53 |
| VB12 | TGATCCATTACTCATATGGTGTTAAA | 54 |
| VB13 | GATTCATTACTCAGTTGGTGAGGG | 55 |
| VB14 | CAGATCTACTATTCAATGAATGTTGAG | 56 |
| VB15 | GGTTGATCTATTACTCCTTTGATGTC | 57 |
| VB16 | TAACCTTTATTGGTATCGACGTGT* | 58 |
| VB17 | CTACTCACAGATAGTAAATGACTTTCAG | 59 |
| VB18 | TCATGTTTACTGGTATCGGCAG* | 60 |
| VB19 | TTATGTTTATTGGTATCAACAGAATCA* | 61 |
| VB20 | GGTATTGGCCAGATCAGCTCT | 62 |
| VB23 | TCTTCATTTCGTTTTATGAAAAGATG | 63 |
| VB24 | CGTCATGTACTGGTACCAGCA* | 64 |
| VB25 | TGGTACCAACAGGTCCTGAAA | 65 |
| VB27 | TGGTACAGACAGAAAGCTAAGAAAT | 66 |
| VB28 | GTCTATTATTCACCTGGCACTGG | 67 |
| VB29 | GGCAGGACCCAAAGCAAAAT | 68 |
| VB30 | TAAGACCAAGAATAGGGGCTGAG | 69 |
| CB | GTGCTGACCCCACTGTGC | 70 |

*Sequences derived from van Dongen et at. (2005) Leukemia. 17: 2257-2317.

PCR product (300 ng) from reference (RT-PCR products from pooled RNA of healthy adult donors) or a test sample was labeled with random primer for 2 hours at 37° C. with the appropriate cyanine dye (Cy3 or Cy5) by using a BIOPRIME® DNA labeling kit (Invitrogen). Unincorporated dye was removed by passage over a Qiagen spin column. The labeled probes were combined and dried by speed vacuum. Hybridization was performed at 50° C. for 6 hours on a Ventana DISCOVERY™ Hybridization Station (Ventana Medical System, Tucson, Ariz.). The reagents and protocols for hybridization and washing were provided by the manufacturer. The hybridized slides were scanned by using an Axon 4000B dual-channel scanner (Molecular Devices Corporation, Sunnyvale, Calif.) to generate a multi-TIFF image. Images were analyzed by using Axon GENEPIX® 4.1 image analysis software, and generated text-data files were imported into SPOTFIRE™ DECISIONSITE® (version 8.2. 1; Spotfire, Somerville, Mass.) for the data analysis. A series of filtration algorithms were applied to eliminate spots with poor quality data. The following spots were excluded from further analysis: spots flagged (as bad, absent, or not found) by the image analysis software, spots having a signal-to-noise ratio ≦1.5 in both Cy3 and Cy5 channels, and spots with a background-corrected signal reading ≦200 in the test sample channel (Cy5). Global normalization of Cy5/Cy3 signals was applied to all chips except those used for the 1 month post-AHSCT patient samples. The output, a tab-delimited file, was imported to an Excel spreadsheet where the results of replicate tests were combined by averaging the signal intensities and log₂ ratios. TCRβ gene families in which fewer than 50% of the replicates met qualitative spot criteria were excluded. The family percentage profile was plotted on the basis of normalized signal intensity.

The specificity of each of the 27 Vβ and 13 Jβ probes on the array was examined by amplifying each TCRβ target from the pooled cDNA of PBMNC by using a specific Vβ or Jβ primer combined with the Cβ primer. Each PCR product was then labeled with Cy5 and hybridized to the array. A Cy3-labeled normal reference sample was generated by amplification of the pooled PBMNC cDNA using a mixture of all 27 Vβ primers combined with the Cβ primer. A series of filtration and global normalization (described above) were performed, but test channel (Cy5) intensity of at least 200 was not applied.

The Vβ/Jβ combination score (VJCS) is based on the generic concept that each Vβ can potentially combine with multiple Jβ. Multiplication of the numbers of Vβ and Jβ families expressed provides an estimate of the potential numbers of T cell populations that differ in their TCR Vβ/Jβ combinations. The VJCS for each sample is calculated as follows:

VJCS=(number of Vβ families expressed+1)×(number of Jβ families expressed+1)

### TCRβ CDR3 Size Spectratyping

TCRβ CDR3 size distribution was determined as described previously (Chen et al. (2005) Blood 105: 886-893. The PCR fragments were run on an ABI PRISM® 3100 Genetic Analyzer (Applied Biosystems) and data were collected and analyzed by GENEMAPPER® software version 3.7. The overall complexity of TCRβ subfamilies was calculated as the spectratype complexity score (SCS) as described by Wu et al., supra. Each Vβ family's spectratype density was expressed as a percentage of the spectratype density of total Vβ families tested.

### Flow Cytometric Analysis

Four-color multiparameter immunophenotyping analysis was performed by a whole-blood lysis technique previously described (Chen et al., 2005, supra). The monoclonal antibodies used were anti-CD3-APC, anti-Vβ2, -3, -5S1, -6S1, -11, -12, -13, -14, -16, -17, and -20 conjugated to FITC; and anti Vβ 5S3, -7, -9, -18, and -23 conjugated to PE. All cell populations were measured by gating on CD3⁺ cells. The final percentage of each Vβ family was calculated as a proportion of the total Vβ family population.

### Statistical Analysis

Spearman correlation was used to assess the relationship of Vβ percentages among the three techniques (Vβ microarray, spectratyping and flow cytometry). The one sample t test was used to assess the difference between Vβ microarray and flow cytometry, and between spectratyping and flow cytometry separately for each Vβ family in 10 healthy controls. The two-tailed p-values were considered to be significant at α=0.0031 (0.05/16) after Bonferroni adjustment for multiple comparisons of mean differences of Vβ percentages. One sample t test was used to test if the microarray could distinguish a monoclonal T cell increase from a polyclonal T cell population. The criterion for significance for all analyses was a two-tailed p-value at level of α=0.05 unless otherwise stated. All statistical analyses were performed with the statistical software package SAS, release 9.1 (Cary, N.C.).

### Results

### Specificity of the TCRβ Oligonucleotide Microarray

Because TCRβ gene segments are highly related, oligonucleotide probes with maximum specificity for each TCRβ region were first designed and the sequence similarity among the probes was analyzed with Vector NTI software. Most probes had less than 60% identity to other probes. However, the TCR Jβ probes showed approximately 61%-84% similarity to other Jβ probes. Then the specificity of each of the 27 Vβ and 13 Jβ probes on the array was tested by hybridizing labeled PCR products representing each of the Vβ or Jβ regions onto the array (described above). The highest signal was always observed in the specific target gene. The difference observed between the specific signal (target gene) and the next highest signal (non-target gene) was an average of 9.6-fold (Vβ vs Vβ), 7.0-fold (Jβ vs Jβ), and 9.4-fold (Jβ vs Vβ).

### TCRβ Repertoire Distribution and Vβ/Jβ Combination Score in Healthy Donors

The TCRβ repertoire distribution profiles and expression levels were analyzed in 38 healthy sibling donors by comparison to a reference sample obtained from pooled peripheral blood mononuclear cell (PBMNC) RNA of healthy adult donors. Most TCRβ distribution and expression patterns in the sibling donors were similar to those in the reference sample, showing less than 2-fold variation. A few Vβ families (Vβ3, 14, 15, 20, 23, 24, 28 and 30) showed more than a 2-fold difference from the reference values. By using these results, normal boundaries of TCRβ repertoire distribution were generated, which allowed a quantitative measure of the variation of the T cell population in other test samples. A Vβ/Jβ combination score (VJCS) was also established, which is a qualitative index for the presence/absence of TCRβ gene expression from the total set of Vβ/Jβ families on the array (described above). The VJCS can indicate the extent and clonality of T cell recovery. The VJCS range in the 38 healthy donors was 280-364. The Vβ spectratype complexity scores (SCS) (Wu, 2001, supra) was simultaneously analyzed in these healthy donors and a range of 183-216 was calculated.

### Comparison of TCRβ Repertoire Distribution in Healthy Donors as Detected By Flow Cytometry, TCR Spectratyping and the Microarray

The flow cytometry profiles of 16 Vβ repertoires (available antibodies) in 10 of 38 healthy sibling donors were compared with the profiles obtained by using the microarray or the spectratyping assay. No significant difference in 11 of 16 Vβ families was observed by flow cytometry and microarray assays and no significant difference in 8 of 16 families was observed by flow cytometry and by spectratyping assays. When the microarray and spectratyping analyses were compared, only 5 of 16 Vβ families showed no significant difference. Overall, a better correlation was observed between flow cytometry and the microarray assays than between flow cytometry and the spectratyping methods.

### Detection of Monoclonal T Cells By the Microarray

To test whether the microarray could distinguish a monoclonal T cell increase within a polyclonal T cell population, Jurkat or Molt-4 T-lineage leukemia cell lines were diluted with healthy donor PBMNC. In the Jurkat cell line dilution, the microarray showed increased signals for Vβ 8 and Jβ 1.2 gene segments. Findings were similar for the Molt-4 cell line, which displayed increased expression of Vβ2 and Jβ2.1. The results corresponded with their sequences and Vβ spectratypes. The sensitivity of detection in 10-fold increments of serial dilutions from 100 to 0.001% was then tested. By using Vβmix primer in PCR, the specific signal could be detected in a 1% dilution of the leukemic cell line. The increases in specific signals for mixed samples containing ≧1% leukemia cells differed significantly (p<0.001) from the mean of the normal range.

### Analysis of Patient T Cell Population Diversity Pre- and Post-AHSCT By the Microarray and By Spectratyping.

Sixty PBMNC samples obtained from 20 pediatric patients were tested before and after AHSCT by microarray and by spectratyping. Before AHSCT, the majority of patients (except one patient) had diverse TCRβ repertoire profiles as evidenced by a normal range of expression of multiple TCR Vβ/Jβ genes on the array and a normal VJCS. Similarly, the Vβ spectratypes in the majority of patients (except one same patient) showed Gaussian-like distributions in tested families with a normal range of SCS. One month after AHSCT, the microarray detected only low-level expression of a few Vβ and Jβ genes, resulting in very low VJCS in most patients. Similarly, spectratyping of the same samples showed a restricted TCRβ repertoire displaying monoclonal patterns and very low SCS. Six months after AHSCT, the TCRβ distribution in most patients approached their pre-AHSCT pattern as identified by microarray and spectratyping assays. Their SCS and VJCS values were normal or near-normal. Two patients retained restricted gene expression profiles on the microarray at 6 months post-transplantation, while the spectratyping assay showed a skewed Vβ pattern. Among the 6 month samples, these 2 cases had the lowest estimate of TCR complexity by both the VJCS and the SCS. Overall, there was strong agreement between VJCS and SCS for assessment of TCR population diversity.

The TCRβ expression patterns of 4 patients were compared before and 1 month or 6 months after AHSCT. Before AHSCT, one patient with persistent ALL showed a normal TCRβ distribution profile with a significantly increased (p<0.05) Vβ7-Jβ1.6 T cell monoclonal T cell (potential residual leukemic cells) pre-AHSCT. One month after AHSCT, a restricted expression pattern was seen, with only a few families represented at a very low level. Six months after AHSCT, the profile was normal. The other three patients, who experienced GvHD, also showed normal or near-normal distribution profiles with a significant increase (p<0.001) of monoclonal T cells 6 months after AHSCT. In one patient, several TCRβ gene families were expressed at a lower level than the normal boundary, suggesting a quantitatively incomplete T cell recovery.

### Summary

This invention demonstrates the successful design and use of a TCRβ repertoire-based oligonucleotide microarray for analysis of the T cell population diversity after AHSCT. This device has broad potential application for monitoring T cell mediated immunity in many other clinical and research settings.

The signals generated by specific target and non-target TCRβ gene expression are distinct, suggesting that the 38- to 62-mer oligonucleotide probes of the present invention are highly specific. Because TCRβ gene segments are highly related, oligonucleotide probes were designed with maximal target-specific regions. Due to restricted diversity and limited segment size, the TCR Jβ probe sequences had about 61%-84% similarity. However, the specific signals were distinct and cross-hybridization within Jβ and Vβ probes, or within Jβ probes was minimal. These findings indicate that 38- to 62-mer oligonucleotide probes can efficiently and specifically hybridize to target gene fragments, whether their similarity is below 60%, or as high as 84%. The few observations of cross-hybridization in initial tests were eliminated by refinement of amplification primers or by using cloned specific products. These results imply that because of the high similarity among TCRβ genes, assays depending solely on family-specific PCR primers cannot provide sufficiently specific gene usage information. In contrast, the TCRβ gene-based highly specific capture probes of the present invention can reliably detect individual targets within a heterogeneous mixture. A recent report of TCR Vβ-based multiple ligation and PCR assays describes a method using a universal Padlock microarray (Baner et al. (2005) Clini Chem 51:1-8). In that report, cross-hybridization to non-target genes could occur during the ligation and PCR processes, but this potential mismatching would not be discriminated by the universal microarray.

The TCRβ repertoire distribution of healthy donors was compared using the microarray of the present invention, flow cytometry and TCR spectratyping. The repertoire distribution profiles determined by flow cytometry and by microarray assay were more similar than those determined by flow cytometry and by spectratyping assay. This finding suggests that a sequence-based microarray can provide more accurate protein-output information than can spectratyping. When the microarray and spectratyping assays were compared, 11 of 16 Vβ families showed significant differences. A possible explanation is that some PCR primers commonly used for spectratyping are not sufficiently specific and thus the distribution of TCRβ repertoire is altered by cross-reaction among the TCR transcripts. A sequence-based-oligonucleotide microarray can distinguish specific targets from mixed products and can provide explicit TCRβ repertoire profiles.

Identifying T cell clonality is crucial in assessing T cell mediated immunity. The telling question was whether the microarray could distinguish a T cell monoclonal increase within a polyclonal population, as was hypothesized. Indeed, clearly increased signals for Vβ and Jβ genes corresponding to the sequences and spectratype of Jurkat or Molt-4 T-lineage leukemia cell lines were found. These results strongly indicated that the microarray of the present invention can distinguish monoclonal expansion from a polyclonal population. It accords with the hypothesis that T cell monoclonal expansion will cause increased expression of not only single Vβ but also single Jβ genes regardless of their distinct CDR3 regions, while T cell polyclonal expansion induces multiple Vβ and Jβ gene expression. The success of this finding implies that this microarray can be used to monitor T cell population diversity not only in leukemia, in which it is crucial that specific monoclonal T cells be identified, but also in other settings, including autoimmunity, anti-tumor immunity, vaccination, and infectious diseases. The high specificity, clonality discrimination and simplicity of this microarray offer clear advantages over the recently reported universal microarray, which involved multiple ligation and PCR assays and in which the specificity and clonality were not confirmed.

The sensitivity of detection of monoclonal expansion was also tested. Specific leukemic clones were consistently detected at a 1% concentration in mixed populations. This finding suggests that the TCRβ microarray can detect a monoclonal T cell expansion with a sensitivity comparable to that of the spectratyping assay, which has a maximal sensitivity of 0.5-1% (van Dongen et al. (2005) Leukemia. 17:2257-2317). It also indicates the potential clinical usefulness of the present microarray in rapidly detecting and monitoring leukemic cell clones.

This microarray was used to test 60 samples obtained at different time points from 20 pediatric patients who underwent AHSCT. The variability of the TCRβ gene expression profiles on the microarray before and after AHSCT agreed well with the alteration of their Vβ spectratypes as indicated by changes in the VJCSs and SCSs. These findings suggest that the microarray provides qualitative information on T cell population diversity consistent with that of the spectratyping assay. One month post-AHSCT, fewer TCRβ genes were found to be expressed by the microarray than by the spectratype. Again, it is possible that cross-matching among TCRβ gene families occurred during PCR in the spectratyping assay, whereas this source of error has been further corrected in the sequence-based microarray.

In the tests of patients, the TCRβ microarray provided not only qualitative information (the number of TCRβ genes expressed), but also quantitative data (the level of TCRβ gene expression). For example, the profile of one patient showed incomplete T cell recovery with below-normal representation of T cells 6 month post-AHSCT, while the other 3 patients' profiles showed the numbers and levels of T cells returning to the normal range. The qualitative and quantitative information together provide an extensive assessment of T cell population diversity. With the capability of clonality discrimination, the microarray also successfully recognized increases in T cell monoclonal population within mixed T cell population in patients experiencing GvHD after AHSCT or persistent leukemia (a potential residual leukemic cell clone) before AHSCT. The success of clonality discrimination in patients further confirms the broad usefulness of this TCRβ microarray in the analysis of T cell population diversity and T cell mediated immunity.

That which is claimed:

1. An array for use in a method of monitoring T cell receptor diversity in a subject comprising a substrate having greater than five capture probes, wherein each capture probe can specifically bind a nucleic acid molecule corresponding to a T cell receptor gene family, wherein said T cell receptor gene family is selected from the gene families listed in Table 1.

2. The array of claim 1, wherein said greater than five capture probes are selected from the group consisting of SEQ ID NO:1-41.

3. The array of claim 1, wherein said substrate has greater than 15 capture probes.

4. The array of claim 3, wherein said substrate has greater than 30 capture probes.

5. The array of claim 4, wherein said substrate has greater than 40 capture probes.

6. The array of claim 1, wherein said greater than 5 capture probes are oligonucleotides.

7. The array of claim 6, wherein said oligonucleotides are at least 30 nucleotides in length.

8. The array of claim 7, wherein said oligonucleotides are at least 50 nucleotides in length.

9. The array of claim 1, wherein said substrate is a microarray.

10. A method of monitoring T cell receptor diversity in a test subject comprising:
a) providing the substrate according to claim 1;
b) contacting said substrate with a population of nucleic acid molecules derived from said test subject; and,
c) determining the T cell diversity of the test subject.

11. The method of claim 10, wherein said determining the T cell receptor diversity of the subject in step (c) comprises correlating the T cell receptor diversity of the test sample with the T cell diversity of a control sample.

12. The method of claim 11, wherein the correlation is based on a Vβ/Jβ combination score (VJCS).

13. The method of claim 10 wherein said nucleic acid molecules are derived from the peripheral blood or from a tissue biopsy of said subject.

14. The method of claim 10, wherein said method is useful for monitoring T cell diversity following bone marrow transplant or following therapy for leukemia or lymphoma.

15. The method of claim 10, wherein said method is useful for monitoring T cell diversity for the diagnosis of immunodeficiency diseases, graft versus host disease, autoimmune disease or autoimmune related inflammatory disorders.

16. A kit for evaluating expression of nucleic acid molecules corresponding to T cell receptor gene families comprising:
(a) the substrate according to claim 1; and,
(b) reagents that facilitate either one or both of
(i) hybridization of the nucleic acid to the capture probes; and,
(ii) detection of said hybridization.

17. The kit of claim 16 further comprising a computer readable storage medium comprising logic which enables a processor to read data representing detection of hybridization.

18. The kit of claim 16 wherein the detection employs fluorescence.


SEQUENCE LISTING (70 sequences)

SEQ ID NO: 1 - DNA, 53 bp, Artificial Sequence
  Oligonucleotide probe - VB2
catcaaccatgcaagcctgaccttgtccactctgacagtgaccagtgcccatc

SEQ ID NO: 2 - DNA, 56 bp, Artificial Sequence
  Oligonucleotide
agtgtctctagagagaagaaggagcgcttctccctgattctggagtccgccagcac

SEQ ID NO: 3 - DNA, 57 bp, Artificial Sequence
  Oligonucleotide
catcagccgcccaaacctaacattctcaactctgactgtgagcaacatgagccctga

SEQ ID NO: 4 - DNA, 58 bp, Artificial Sequence
  Oligonucleotide
ggtcgattctcagggcgccagttctctaactctcgctctgagatgaatgtgagcacct

SEQ ID NO: 5 - DNA, 60 bp, Artificial Sequence
  Oligonucleotide
attctcagctcgccagttccctaactatagctctgagctgaatgtgaacgccttgttgct

SEQ ID NO: 6 - DNA, 57 bp, Artificial Sequence
  Oligonucleotide
gttctttgcagtcaggcctgagggatccgtctctactctgaagatccagcgcacaga

SEQ ID NO: 7 - DNA, 53 bp, Artificial Sequence
  Oligonucleotide
gttctctgcagagaggcctaagggatctttctccaccttggagatccagcgca

SEQ ID NO: 8 - DNA, 57 bp, Artificial Sequence
  Oligonucleotide
cctgaatgccccaacagctctcacttattccttcacctacacaccctgcagccagaa

SEQ ID NO: 9 - DNA, 60 bp, Artificial Sequence
  Oligonucleotide
tcagctaagatgcctaatgcatcattctccactctgaggatccagccctcagaacccagg

SEQ ID NO: 10 - DNA, 60 bp, Artificial Sequence
  Oligonucleotide
cacctaaatctccagacaaagctcacttaaatcttcacatcaattccctggagcttggtg

SEQ ID NO: 11 - DNA, 57 bp, Artificial Sequence
  Oligonucleotide
agcccaatgctccaaaaactcatcctgtaccttggagatccagtccacggagtcagg

SEQ ID NO: 12 - DNA, 50 bp, Artificial Sequence
  Oligonucleotide
gagcattttcccctgaccctggagtctgccaggccctcacatacctctca

SEQ ID NO: 13 - DNA, 60 bp, Artificial Sequence
  Oligonucleotide
agtgtctctagatcaaagacagaggatttcctcctcactctggagtccgctaccagctcc

SEQ ID NO: 14 - DNA, 50 bp, Artificial Sequence
  Oligonucleotide
tccagatcaaccacagaggatttcccgctcaggctggagtcggctgctcc

SEQ ID NO: 15 - DNA, 53 bp, Artificial Sequence
  Oligonucleotide
agtctctcgaaaagagaagaggaatttccccctgatcctggagtcgcccagcc

SEQ ID NO: 16 - DNA, 60 bp, Artificial Sequence
  Oligonucleotide
gatacagtgtctctcgacaggcacaggctaaattctccctgtccctagagtctgccatcc

SEQ ID NO: 17 - DNA, 60 bp, Artificial Sequence
  Oligonucleotide
gactggagggacgtattctactctgaaggtgcagcctgcagaactggaggattctggagt

SEQ ID NO: 18 - DNA, 53 bp, Artificial Sequence
  Oligonucleotide
agcgtctctcgggagaagaaggaatcctttcctctcactgtgacatcggccca

SEQ ID NO: 19 - DNA, 52 bp, Artificial Sequence
  Oligonucleotide
atttcccaaagagggccccagcatcctgaggatccagcaggtagtgcgagga

SEQ ID NO: 20 - DNA, 60 bp, Artificial Sequence
  Oligonucleotide
agaatgaacaagttcttcaagaaacggagatgcacaagaagcgattctcatctcaatgcc

SEQ ID NO: 21 - DNA, 57 bp, Artificial Sequence
  Oligonucleotide
ccaggaccggcagttcatcctgagttctaagaagctccttctcagtgactctggctt

SEQ ID NO: 22 - DNA, 62 bp, Artificial Sequence
  Oligonucleotide
tcgattctcagctcaacagttcagtgactatcattctgaactgaacatgagctccttggagc

SEQ ID NO: 23 - DNA, 55 bp, Artificial Sequence
  Oligonucleotide
aatccaggaggccgaacacttctttctgctttcttgacatccgctcaccaggcct

SEQ ID NO: 24 - DNA, 60 bp, Artificial Sequence
  Oligonucleotide
tcagctaagtgcctcccaaattcaccctgtagccttgagatccaggctacgaagcttgag

SEQ ID NO: 25 - DNA, 58 bp, Artificial Sequence
  Oligonucleotide
atgccctgacagctctcgcttataccttcatgtggtcgcactgcagcaagaagactca

SEQ ID NO: 26 - DNA, 60 bp, Artificial Sequence
  Oligonucleotide
ttgaaatactatagcatcttttcccctgaccctgaagtctgccagcaccaaccagacatc

SEQ ID NO: 27 - DNA, 54 bp, Artificial Sequence
  Oligonucleotide
caagaggagaaggggctatttcttctcagggtgaagttggcccacaccagccaa

SEQ ID NO: 28 - DNA, 60 bp, Artificial Sequence
  Oligonucleotide
tggaaacaagctcaagcattttccctcaaccctggagtctactagcaccagccagacctc

SEQ ID NO: 29 - DNA, 42 bp, Artificial Sequence
  Oligonucleotide
acactgaagctttctttggacaaggcaccagactcacagttg

SEQ ID NO: 30 - DNA, 42 bp, Artificial Sequence
  Oligonucleotide
actatggctacaccttcggttcggggaccaggttaaccgttg

SEQ ID NO: 31 - DNA, 44 bp, Artificial Sequence
  Oligonucleotide
tggaaacaccatatattttggagagggaagttggctcactgttg

SEQ ID NO: 32 - DNA, 45 bp, Artificial Sequence
  Oligonucleotide
ctaatgaaaaactgttttttggcagtggaacccagctctctgtct

SEQ ID NO: 33 - DNA, 44 bp, Artificial Sequence
  Oligonucleotide
caatcagccccagcattttggtgatgggactcgactctccatcc

SEQ ID NO: 34 - DNA, 47 bp, Artificial Sequence
  Oligonucleotide
tataattcacccctccactttgggaatgggaccaggctcactgtgac

SEQ ID NO: 35 - DNA, 44 bp, Artificial Sequence
  Oligonucleotide
ctacaatgagcagttcttcgggccagggacacggctcaccgtgc

SEQ ID NO: 36 - DNA, 45 bp, Artificial Sequence
  Oligonucleotide
acaccggggagctgttttttggagaaggctctaggctgaccgtac

SEQ ID NO: 37 - DNA, 43 bp, Artificial Sequence
  Oligonucleotide
acagatacgcagtattttggcccaggcacccggctgacagtgc

SEQ ID NO: 38 - DNA, 40 bp, Artificial Sequence
  Oligonucleotide
aacattcagtacttcggcgccgggacccggctctcagtgc

SEQ ID NO: 39 - DNA, 40 bp, Artificial Sequence
  Oligonucleotide
aagagacccagtacttcgggccaggcacgcggctcctggt

SEQ ID NO: 40 - DNA, 38 bp, Artificial Sequence
  Oligonucleotide
aacgtcctgactttcggggccggcagcaggctgaccgt

SEQ ID NO: 41 - DNA, 42 bp, Artificial Sequence
  Oligonucleotide
ctacgagcagtacttcgggccgggcaccaggctcacggtcac

SEQ ID NO: 42 - DNA, 21 bp, Artificial Sequence
  Oligonucleotide
aactatgttttggtatcgtca

SEQ ID NO: 43 - DNA, 28 bp, Artificial Sequence
  Oligonucleotide
tctatttctcatatgatgttaaaatgaa

SEQ ID NO: 44 - DNA, 24 bp, Artificial Sequence
  Oligonucleotide
cacgatgttctggtaccgtcagca

SEQ ID NO: 45 - DNA, 22 bp, Artificial Sequence
  Oligonucleotide
cagtgtgtcctggtaccaacag

SEQ ID NO: 46 - DNA, 22 bp, Artificial Sequence
  Oligonucleotide
cagtgtgtcctggtaccaacag

SEQ ID NO: 47 - DNA, 21 bp, Artificial Sequence
  Oligonucleotide
aaccctttattggtaccgaca

SEQ ID NO: 48 - DNA, 21 bp, Artificial Sequence
  Oligonucleotide
aaccctttattggtaccgaca

SEQ ID NO: 49 - DNA, 21 bp, Artificial Sequence
  Oligonucleotide
gccactggagctcatgtttgt

SEQ ID NO: 50 - DNA, 25 bp, Artificial Sequence
  Oligonucleotide
ctcccgttttctggtacagacagac

SEQ ID NO: 51 - DNA, 22 bp, Artificial Sequence
  Oligonucleotide
cgctatgtattggtataaacag

SEQ ID NO: 52 - DNA, 26 bp, Artificial Sequence
  Oligonucleotide
ttatgtttactggtatcgtaagaagc

SEQ ID NO: 53 - DNA, 22 bp, Artificial Sequence
  Oligonucleotide
caaaatgtactggtatcaacaa

SEQ ID NO: 54 - DNA, 26 bp, Artificial Sequence
  Oligonucleotide
tgatccattactcatatggtgttaaa

SEQ ID NO: 55 - DNA, 24 bp, Artificial Sequence
  Oligonucleotide
gattcattactcagttggtgaggg

SEQ ID NO: 56 - DNA, 27 bp, Artificial Sequence
  Oligonucleotide
cagatctactattcaatgaatgttgag

SEQ ID NO: 57 - DNA, 26 bp, Artificial Sequence
  Oligonucleotide
ggttgatctattactcctttgatgtc

SEQ ID NO: 58 - DNA, 24 bp, Artificial Sequence
  Oligonucleotide
taacctttattggtatcgacgtgt

SEQ ID NO: 59 - DNA, 28 bp, Artificial Sequence
  Oligonucleotide
ctactcacagatagtaaatgactttcag

SEQ ID NO: 60 - DNA, 22 bp, Artificial Sequence
  Oligonucleotide
tcatgtttactggtatcggcag

SEQ ID NO: 61 - DNA, 27 bp, Artificial Sequence
  Oligonucleotide
ttatgtttattggtatcaacagaatca

SEQ ID NO: 62 - DNA, 21 bp, Artificial Sequence
  Oligonucleotide
ggtattggccagatcagctct

SEQ ID NO: 63 - DNA, 26 bp, Artificial Sequence
  Oligonucleotide
tcttcatttcgttttatgaaaagatg

SEQ ID NO: 64 - DNA, 21 bp, Artificial Sequence
  Oligonucleotide
cgtcatgtactggtaccagca

SEQ ID NO: 65 - DNA, 21 bp, Artificial Sequence
  Oligonucleotide
tggtaccaacaggtcctgaaa

SEQ ID NO: 66 - DNA, 25 bp, Artificial Sequence
  Oligonucleotide
tggtacagacagaaagctaagaaat

SEQ ID NO: 67 - DNA, 23 bp, Artificial Sequence
  Oligonucleotide
gtctattattcacctggcactgg

SEQ ID NO: 68 - DNA, 20 bp, Artificial Sequence
  Oligonucleotide
ggcaggacccaaagcaaaat

SEQ ID NO: 69 - DNA, 23 bp, Artificial Sequence
  Oligonucleotide
taagaccaagaataggggctgag

SEQ ID NO: 70 - DNA, 18 bp, Artificial Sequence
  Oligonucleotide
gtgctgaccccactgtgc